(19) United States
(12) Patent Application Publication
(10) Pub. No.: US 2024/0410619 A1
(43) Pub. Date: Dec. 12, 2024

(54) HOT WATER SUPPLY APPARATUS

(71) Applicant: NORITZ CORPORATION, HYOGO (JP)

(72) Inventors: Keiichiro IWANAMI, HYOGO (JP); Yoshifumi ATOBE, HYOGO (JP); Kenichi NAKAYAMA, HYOGO (JP)

(73) Assignee: NORITZ CORPORATION, HYOGO (JP)

(21) Appl. No.: 18/732,561

(22) Filed: Jun. 3, 2024

(30) Foreign Application Priority Data
Jun. 12, 2023 (JP) 2023-096159

(51) Int. Cl. F24H 9/20; F24H 1/10; F24H 15/174; F24H 15/238; F24H 15/31; F24H 15/355

(52) U.S. Cl. CPC F24H 9/2028; F24H 1/10; F24H 15/174; F24H 15/238; F24H 15/31; F24H 15/355

(57) ABSTRACT

A hybrid valve is configured so that a first section and a second section exist with respect to an opening degree control value. In the first section, the flow rate ratio of the high-temperature water flow rate and the low-temperature water flow rate changes; and in the second section, the flow rate ratio is fixed while the total flow rate changes. When the total flow rate is equal to or less than the limit flow rate, temperature control in which the hybrid valve operates in the first section is executed. When the total flow rate is greater than the limit flow rate, flow rate control in which the hybrid valve operates in the second section is executed. During temperature control, the heating amount of combustion burners is adjusted to control a can body temperature to a can body setting temperature set to decrease as the total flow rate increases.

### CROSS-REFERENCE TO RELATED APPLICATION

This application claims the priority benefits of Japanese application no. 2023-096159, filed on Jun. 12, 2023. The entirety of the above-mentioned patent application is hereby incorporated by reference herein and made a part of this specification.

### BACKGROUND

### Technical Field

The disclosure relates to a hot water supply apparatus, and more particularly relates to a bypass mixing type hot water supply apparatus that mixes high-temperature water and low-temperature water.

### Description of Related Art

A bypass mixing type hot water supply apparatus has been used to adjust the hot water outlet temperature by controlling the flow rate ratio of high-temperature water that passes through a heat exchanger and low-temperature water that bypasses the heat exchanger.

Japanese Patent No. 3067498 (Patent Document 1) describes a configuration in which the valve opening degree of a bypass valve (distribution valve) for controlling the flow rate ratio of high-temperature water and low-temperature water is controlled by the number of steps of a stepping motor. Patent Document 1 describes that the number of steps of the stepping motor is set by correcting the target number of steps, which is calculated backward from the target flow rate ratio, using the correction number of steps in accordance with the reference characteristic relationship that has been obtained in advance between the number of steps (valve opening degree) and the flow rate ratio in the bypass valve. The correction number of steps is calculated based on the deviation between the actual flow rate ratio calculated from the detected temperature and the target flow rate ratio.

Further, Japanese Patent No. 4823149 (Patent Document 2) describes one type of mixing valve for mixing hot water and cold water to output warm water, which also has a function of restricting only the amount of hot water with the water inlet fully closed. Specifically, the mixing valve of Patent Document 2 has characteristics that there are a first section and a second section according to the valve opening degree of the mixing valve. In the first section, the opening areas of the water inlet and the hot water inlet are linked to gradually decrease and gradually increase, respectively; and in the second section, the opening area of the hot water inlet changes from the maximum value to the minimum value with the water inlet fully closed.

It is understood that the first section and the second section exist in the mixing valve described in Patent Document 2, wherein in the first section, the flow rate ratio (mixture ratio) changes according to the valve opening degree without affecting the output flow rate from the mixing valve (that is, the total flow rate of water and hot water), and in the second section, the output flow rate from the mixing valve changes according to the valve opening degree while the mixture ratio of water and hot water is fixed (all hot water).

Here, assuming that the mixing valve of Patent Document 2 is applied to the bypass valve of the hot water supply apparatus of Patent Document 1, in temperature control when the mixing valve operates in the first section, the hot water outlet temperature can be controlled by adjusting the flow rate ratio, so the temperature of high-temperature water does not affect the hot water outlet temperature directly. In contrast, in temperature control when the mixing valve operates in the second section, the flow rate ratio is fixed, so the temperature of high-temperature water directly affects the hot water outlet temperature. Thus, there is a concern that the accuracy of temperature control may decrease when switching from temperature control in which the mixing valve operates in the first section to temperature control in which the mixing valve operates in the second section.

In view of the above, the disclosure improves the accuracy of temperature control in a bypass mixing type hot water supply apparatus that uses a control valve having a region where the flow rate ratio does not change in response to a change in the control value.

### SUMMARY

In one aspect of the disclosure, a hot water supply apparatus is provided. The hot water supply apparatus for mixing low-temperature water and high-temperature water includes a heating part, a first flow path, a second flow path, a flow rate detector, a control valve, and a control device. The heating part outputs high-temperature water by heating the low-temperature water. The first flow path allows the low-temperature water to flow through the heating part. The second flow path allows the low-temperature water to flow through without passing through the heating part. The flow rate detector is disposed in the first flow path or the second flow path. The control valve is connected to the first flow path and the second flow path and controls flow rates of the first flow path and the second flow path. The control device sets a control value of the control valve and a heating amount provided by the heating part in order to control a hot water outlet temperature after mixing of the low-temperature water and the high-temperature water to a hot water supply setting temperature. The control valve is configured so that a first section and a second section exist with respect to a change in the control value. In the first section, a flow rate ratio of the first flow path and the second flow path changes without affecting a total flow rate of the first flow path and the second flow path, and in the second section, the flow rate ratio is fixed while the total flow rate decreases. In a case where the total flow rate acquired based on a detection flow rate of the flow rate detector is greater than a limit flow rate set corresponding to a maximum heating amount of the heating part, the control device sets the control value of the control valve within the second section so that the total flow rate is equal to or less than the limit flow rate, and controls the heating amount of the heating part so as to control the hot water outlet temperature to the hot water supply setting temperature. In a case where the total flow rate acquired based on the detection flow rate of the flow rate detector is equal to or less than the limit flow rate, the control device controls the heating amount of the heating part so as to control a temperature of the high-temperature water to a can body setting temperature, and sets the control value of the control valve within the first section in accordance with the flow rate ratio for controlling the hot water outlet temperature to the hot water supply setting temperature. The can body setting temperature is set so that a flow rate region exists, in which the can body setting temperature decreases as the total flow rate increases and approaches the limit flow rate.

According to the disclosure, it is possible to improve the accuracy of temperature control in a bypass mixing type hot water supply apparatus that uses a control valve having a region where the flow rate ratio does not change in response to a change in the control value.

### BRIEF DESCRIPTION OF THE DRAWINGS

FIG. 1 is a schematic configuration diagram of a hot water supply apparatus according to an embodiment of the disclosure.

FIG. 2 is a conceptual diagram illustrating the input and output of the hybrid valve applied to the hot water supply apparatus of FIG. 1.

FIG. 3 is a conceptual diagram showing the characteristics of the hybrid valve applied to the hot water supply apparatus of FIG. 1.

FIG. 4 is a flowchart illustrating the control process for the hybrid valve in the hot water supply apparatus according to an embodiment of the disclosure.

FIG. 5 is a flowchart illustrating the combustion control of the heating part in the hot water supply apparatus according to an embodiment of the disclosure.

FIG. 6 is a conceptual diagram illustrating a comparative example of setting of the can body setting temperature.

FIG. 7 is a conceptual diagram illustrating an example of setting the can body setting temperature according to an embodiment of the disclosure.

### DESCRIPTION OF THE EMBODIMENTS

Hereinafter, embodiments of the disclosure will be described in detail with reference to the drawings. In the following, the same or corresponding parts in the drawings will be denoted by the same reference numerals, and the description thereof will not be repeated in principle.

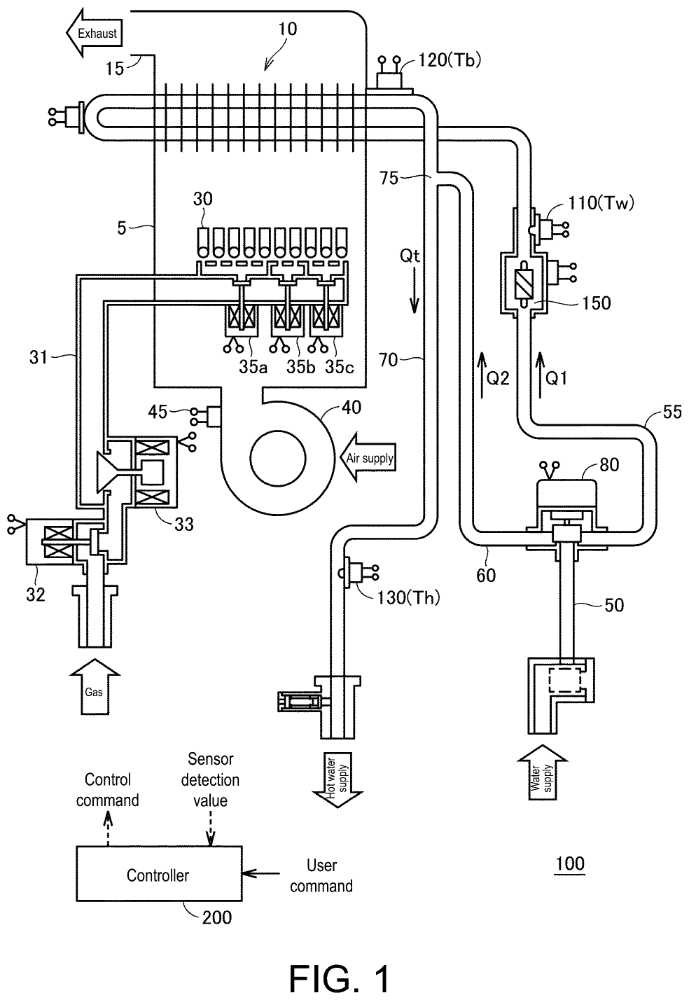

FIG. 1 is a schematic configuration diagram of a hot water supply apparatus 100 according to an embodiment of the disclosure.

With reference to FIG. 1, the hot water supply apparatus 100 includes a combustion can body (hereinafter, also simply referred to as “can body”) 5 that houses a heat exchanger 10 and combustion burners 30, a blower fan 40, a water inlet passage 50, a can body piping 55, a bypass piping 60, a hot water outlet passage 70, a hybrid valve 80, and a controller 200.

The water inlet passage 50 is connected to the can body piping 55 and the bypass piping 60 via the hybrid valve 80. Low-temperature water such as tap water is supplied to the water inlet passage 50. The low-temperature water in the water inlet passage 50 passes through the hybrid valve 80 and is distributed to the can body piping 55 and the bypass piping 60. In this embodiment, a “control valve” for controlling the flow rate ratio of high-temperature water and low-temperature water in a bypass mixing system is configured using the hybrid valve 80 having characteristics that will be described later.

The can body piping 55 causes the low-temperature water to flow through the heat exchanger 10. The low-temperature water introduced from the water inlet passage 50 into the can body piping 55 is heated by the amount of heat generated by the combustion burners 30 as the low-temperature water passes through the heat exchanger 10. Thereby, high-temperature water is output from the heat exchanger 10.

A main gas solenoid valve 32, a gas proportional valve 33, and capacity switching valves 35a to 35c are disposed in a gas supply pipe 31 to the combustion burners 30. The main gas solenoid valve 32 has a function of turning on and off the supply of fuel gas to the combustion burners 30. The gas flow rate in the gas supply pipe 31 is controlled according to the opening degree of the gas proportional valve 33.

The capacity switching valves 35a to 35c are controlled to open and close in order to switch the number of burners, among a plurality of combustion burners 30, to which fuel gas is supplied. The amount of heat generated in the can body 5 is proportional to the amount of gas supplied from the entire combustion burners 30, which is determined by the combination of the number of burners and the gas flow rate. Therefore, a setting map that determines a combination of the opening/closing pattern of the capacity switching valves 35a to 35c (number of burners) and the opening degree (gas flow rate) of the gas proportional valve 33 can be created in advance in accordance with the heating amount required for the combustion burners 30.

In the can body 5, the fuel gas output from the combustion burners 30 is mixed with combustion air from the blower fan 40. The amount of air blown by the blower fan 40 is controlled so that the air-fuel ratio with respect to the amount of gas supplied from the entire combustion burners 30 becomes a predetermined value (for example, ideal air-fuel ratio). Since the amount of air blown by the blower fan 40 is proportional to the fan rotation speed, the rotation speed of the blower fan 40 is controlled according to a target rotation speed that is set in response to a change in the amount of gas supplied. The blower fan 40 is provided with a rotation speed sensor 45 for detecting the fan rotation speed.

The mixture of fuel gas and combustion air is ignited by an ignition device (not shown), whereby the fuel gas is combusted to generate a flame. Combustion heat generated by the flame from the combustion burners 30 is provided to the heat exchanger 10 within the can body 5.

The high-temperature water heated by the heat exchanger 10 is output toward the hot water outlet passage 70. An exhaust path 15 is provided downstream of the can body 5 in the flow direction of the combustion gas for exhausting the combustion exhaust gas after heat exchange. The heat exchanger 10 may be configured to include both a primary heat exchanger and a secondary heat exchanger.

The bypass piping 60 and the can body piping 55 are connected at a junction 75. The hot water outlet passage 70 downstream of the junction 75 is supplied with warm water at an appropriate temperature that has been adjusted by mixing high-temperature water from the can body piping 55 and low-temperature water from the bypass piping 60. The warm water from the hot water outlet passage 70 is supplied to a predetermined hot water supply location such as a hot water tap (not shown) in a kitchen or bathroom, or a hot water supply circuit to a bathtub (not shown).

Thus, the hot water supply apparatus 100 has a so-called bypass mixing type configuration in which high-temperature water that passes through the heat exchanger 10 and low-temperature water that bypasses the heat exchanger 10 are mixed through the hybrid valve 80. As will be described later, the flow rate ratio (mixture ratio) of the high-temperature water and the low-temperature water is controlled by an opening degree control value (described later) of the hybrid valve 80 from the controller 200.

Therefore, in the configuration example of FIG. 1, the can body piping 55 forms a “first flow path,” and the bypass piping 60 forms a “second flow path.” Furthermore, the heat exchanger 10 that receives heat from the combustion burners 30 constitutes one embodiment of the “heating part.”

In the following, the flow rate of the can body piping 55 (first flow path) is denoted as Q1, and the flow rate of the bypass piping 60 (second flow path) is denoted as Q2. Further, the hot water outlet flow rate from the hot water outlet passage 70 corresponds to the total flow rate Qt (Qt=Q1+Q2) of the hot water supply apparatus 100, which is the sum of the flow rate Q1 and the flow rate Q2. Each flow rate is a flow rate per unit time, and the unit is, for example, liters/minute.

A temperature sensor 110 is provided upstream of the heat exchanger 10 of the can body piping 55 for detecting the temperature of the low-temperature water. The temperature sensor 110 may be provided in the water inlet passage 50 or the bypass piping 60.

a temperature sensor 120 is disposed downstream of the heat exchanger 10 of the can body piping 55 for detecting the temperature of the high-temperature water. That is, the temperature sensor 120 is disposed upstream of the junction 75. A temperature sensor 130 is disposed in the hot water outlet passage 70 downstream of the junction 75 for detecting the hot water outlet temperature after mixture of high-temperature water and low-temperature water.

In the following, the temperature detected by the temperature sensor 110 is denoted as water inlet temperature Tw, the temperature detected by the temperature sensor 120 is denoted as can body temperature Tb, and the temperature detected by the temperature sensor 130 is denoted as hot water outlet temperature Th.

A flow rate sensor 150 is further disposed in the can body piping 55. The flow rate sensor 150 can be typically configured by an impeller type flow rate sensor. The flow rate sensor 150 detects the flow rate Q1 of the can body piping 55. The flow rate sensor 150 corresponds to one embodiment of the “flow rate detector.”

The controller 200 can be configured by, for example, a microcomputer. The controller 200 receives the values detected by the respective sensors and user operations, and generates control commands to each device in order to control the overall operation of the hot water supply apparatus 100. The user operations include a command to turn on/off the operation switch of the hot water supply apparatus 100 and designation of a hot water supply setting temperature Tr that corresponds to the target value of the hot water outlet temperature.

When the operation switch of the hot water supply apparatus 100 is turned on, the controller 200 turns on the combustion operation in the can body 5 in response to the flow rate Q1 detected by the flow rate sensor 150 exceeding the minimum operating flow quantity (MOQ). When the combustion operation is turned on, the main gas solenoid valve 32 is opened, the supply of fuel gas to the combustion burners 30 is started, and the fuel gas is ignited by the ignition device (not shown). In response to this, the hot water supply apparatus 100 starts the hot water supply operation. During the hot water supply operation, the controller 200 controls the hot water outlet temperature in accordance with the hot water supply setting temperature Tr.

When the operation switch of the hot water supply apparatus 100 is turned off, or when the flow rate Q1 falls below the minimum operating flow quantity (MOQ) during the hot water supply operation, the supply of fuel gas to the combustion burners 30 is stopped, whereby the hot water supply operation is terminated.

Next, the characteristics of the hybrid valve 80 applied to the hot water supply apparatus 100 according to this embodiment will be described in detail.

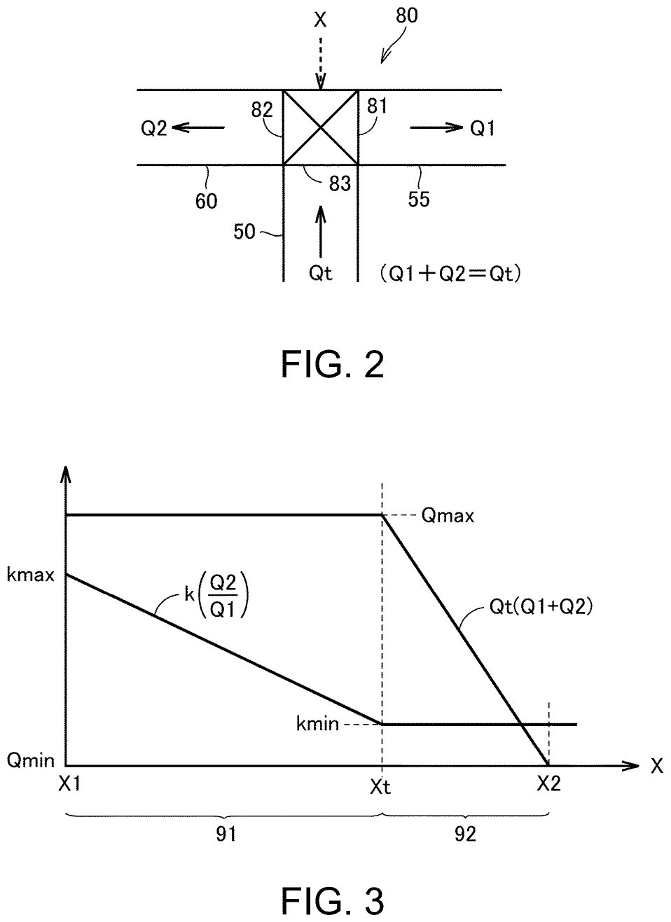

As shown in FIG. 2, the hybrid valve 80 has a first port 81 connected to the can body piping 55, a second port 82 connected to the bypass piping 60, and a third port 83 connected to the water inlet passage 50. The hybrid valve 80 is configured to control the opening degree of one or more valve bodies (not shown) in accordance with the opening degree control value X from the controller 200 so as to change the opening areas of at least a part of the first port 81, the second port 82, and the third port 83, thereby controlling the flow rates Q1 and Q2. For example, the valve body is driven to open and close by a stepping motor (not shown). In this case, the opening degree control value X is indicated by the number of steps of the stepping motor.

As an example, the opening areas of the first port 81 and the second port 82 respectively change according to the opening degree of the first valve body (not shown), while the sum of the two opening areas is controlled to maintain a constant value. On the other hand, the opening area of the third port 83 is controlled according to the opening degree of the second valve body (not shown).

The flow rate Q1 of the can body piping 55 changes according to the opening area of the first port 81 and the flow rate Q2 of the bypass piping 60 changes according to the opening area of the second port 82, while the sum of the opening areas of the first port 81 and the second port 82 is constant. Therefore, the flow rate ratio k (defined as k=Q2/Q1) of the flow rate Q1 and the flow rate Q2 changes according to the opening degree of the first valve body described above.

Furthermore, since the sum of the opening areas of the first port 81 and the second port 82 is constant, the total flow rate Qt (Q1+Q2) changes in accordance with the opening area of the third port 83 according to the opening degree of the second valve body described above.

FIG. 3 shows a characteristic diagram of the hybrid valve 80 with respect to the opening degree control value X.

As shown in FIG. 3, the hybrid valve 80 is configured so that a first section (X=X1 to Xt) and a second section (X=Xt to X2) exist with respect to the opening degree control value X which changes between the minimum value X1 and the maximum value X2. In the first section (X=X1 to Xt), the flow rate ratio k changes without affecting the total flow rate Qt; and in the second section (X=Xt to X2), the total flow rate Qt changes while the flow rate ratio k is set to a constant value. Hereinafter, the first section is also referred to as a “temperature control region 91” and the second section is also referred to as a “flow rate control region 92.”

The total flow rate Qt is maintained at the maximum flow rate Qmax in the temperature control region 91 (X=X1 to Xt), while being controlled to decrease from the maximum flow rate Qmax to the minimum flow rate Qmin as the opening degree control value X increases in the flow rate control region 92 (X=Xt to X2).

In contrast, the flow rate ratio k is controlled to gradually decrease from the maximum value kmax to the minimum value kmin as the opening degree control value X increases in the temperature control region 91 (X=X1 to Xt), while being maintained at the minimum value kmin at X=Xt in the flow rate control region 92 (X=Xt to X2).

For example, the hybrid valve 80 can be configured so that in the temperature control region 91, the opening area of the first port 81 gradually increases as the opening degree control value X increases from the minimum value X1 to the boundary value Xt, while the opening areas of the first port 81 and the second port 82 are changed in conjunction with each other so that the opening area of the second port 82 gradually decreases, while the opening area of the third port 83 is maintained at the maximum value independent of the opening degree control value X in the temperature control region 91. Thus, the characteristics of the flow rate ratio k and the total flow rate Qt with respect to the opening degree control value X in the temperature control region 91 shown in FIG. 3 are realized. The maximum flow rate Qmax is determined by the pressure of the low-temperature water introduced into the water inlet passage 50 (for example, the water pressure of the water supply) and the opening degree of the hot water tap (not shown) at the hot water supply destination.

In addition, the hybrid valve 80 can be configured so that in the flow rate control region 92, the opening area of the third port 83 gradually decreases as the opening degree control value X increases from the boundary value Xt to the maximum value X2, while the opening areas of the first port 81 and the second port 82 are maintained in the state when X=Xt. Thus, the characteristics of the flow rate ratio k and the total flow rate Qt with respect to the opening degree control value X in the flow rate control region 92 shown in FIG. 3 are realized. The hybrid valve 80 controls the flow rate Q1 (high-temperature water) and the flow rate Q2 (low-temperature water) according to the characteristics of the flow rate ratio (Q2/Q1) and the total flow rate (Q1+Q2) shown in FIG. 3.

The flow rate ratio kmin may be set so that a flow rate occurs in the bypass piping 60 even in the flow rate control region 92 (Q2>0, kmin>0), and the flow rate ratio kmin in the flow rate control region 92 may be set to kmin=0 (that is, Q2=0) by setting the second port 82 to a fully closed state at X=X2.

Furthermore, the minimum flow rate Qmin of the total flow rate Qt when the opening degree control value X is at the maximum value X2 can be set to Qmin=0 by setting the third port 83 to a fully closed state. On the other hand, at X=X2, it is also possible to set Qmin>0 by not setting the third port 83 to a fully closed state. However, as described above, when the flow rate Q1 falls below the minimum operating flow quantity (MOQ), the combustion in the combustion burners 30 is stopped.

Therefore, the hot water supply apparatus 100 can control the hot water outlet temperature Th to the hot water supply setting temperature Tr by adjusting the flow rate ratio k according to the opening degree control value X of the hybrid valve 80 in the temperature control region 91. When the maximum heating amount Pmax at the time when the amount of heat generated by the combustion burners 30, that is, the “heating part,” in the hot water supply apparatus 100 is set to the maximum value (for example, gas flow rate maximum value and combustion by all burners) is equal to or greater than the required heating amount Prq (Prq=Qt·ΔT) according to the product of the total flow rate Qt and the temperature rise amount ΔT=Tr−Tw (Prq≤Pmax), it is understood that it is possible to control the hot water outlet temperature by adjusting the flow rate ratio k in the temperature control region 91.

On the other hand, in the case where the required heating amount Prq becomes greater than the maximum heating amount Pmax (Prq>Pmax), if the total flow rate Qt is not reduced from the maximum flow rate Qmax, the hot water outlet temperature Th cannot be raised to the hot water supply setting temperature Tr. Therefore, it is necessary to control the hot water outlet temperature by adjusting the total flow rate Qt in the flow rate control region 92.

The above-mentioned relationship between the required heating amount Prq and the maximum heating amount Pmax can also be expressed by the total flow rate Qt. Here, if the maximum value of the total flow rate Qt that can raise the water inlet temperature Tw to the hot water supply setting temperature Tr under the condition that the maximum heating amount Pmax is generated is defined as the limit flow rate Qlm, the limit flow rate Qlm can be expressed by the following formula (1) using the thermal efficiency η (η=1.0). In the following, for the sake of simplicity, η=1.0 will be used.

$$Ql m = η \cdot P max / ( Tr - Tw ) \qquad ( 1 )$$

Therefore, by comparing the limit flow rate Qlm with the total flow rate Qt, it is possible to determine to control the hot water outlet temperature by adjusting the flow rate ratio k in the temperature control region 91 when Qt≤Qlm, while controlling the hot water outlet temperature by adjusting the total flow rate Qt in the flow rate control region 92 (Qt≤Qlm) when Qt>Qlm. That is, it is understood that the determination based on comparison between the limit flow rate Qlm and the total flow rate Qt is equivalent to the determination based on comparison between the required heating amount Prq and the maximum heating amount Pmax.

In addition, even in the case where the flow rate Q1 of the can body piping 55 becomes the upper limit flow rate (can body maximum flow rate Q1max) in terms of the durability performance of the heat exchanger 10, it is also possible to further combine flow rate control for setting Q1≤Q1max by operating the hybrid valve 80 in the flow rate control region 92. In this case, when the flow rate value obtained by converting the can body maximum flow rate Q1max into the total flow rate using the flow rate ratio k is smaller than the flow rate value calculated by the above formula (1), flow rate control for limiting to Q1≤Q1max can be performed by setting the flow rate value converted from the can body maximum flow rate Q1max to the limit flow rate Qlm.

Here, the relationship of the following formula (2) is established among the flow rate Q1 of the can body piping 55, the flow rate Q2 of the bypass piping 60, the can body temperature Tb, the water inlet temperature Tw, and the hot water outlet temperature Th.

$$Q 2 \cdot ( Th - Tw ) = Q 1 \cdot ( Tb - Th ) \qquad ( 2 )$$

From formula (2), the flow rate ratio k (k=Q2/Q1) can be expressed by formula (3) based on the can body temperature Tb, the water inlet temperature Tw, and the hot water outlet temperature Th.

$$k = Q 2 / Q 1 = ( Tb - Th ) / ( Th - Tw ) \qquad ( 3 )$$

Therefore, the flow rate ratio k* for controlling the hot water outlet temperature Th to the hot water supply setting temperature Tr can be calculated by the following formula (4), which replaces the hot water outlet temperature Th in formula (2) with the hot water supply setting temperature Tr.

$${k}^{*} = Q 2 / Q 1 = ( Tb - Tr ) / ( Tr - Tw ) \qquad ( 4 )$$

Theoretically, by setting the flow rate ratio of the hybrid valve 80 according to the flow rate ratio k* calculated by formula (4), the hot water outlet temperature Th can be controlled to the hot water supply setting temperature Tr.

On the other hand, during the hot water supply operation, the temperatures detected by the temperature sensors 110, 120, and 130 can be substituted into formula (3) to sequentially calculate the actual flow rate ratio k calculated backward from the actual temperature value. Hereinafter, the flow rate ratio thus obtained will be referred to as the actual flow rate ratio ktm.

For example, by measuring the actual flow rate ratio ktm with respect to the opening degree control value X of the hybrid valve 80 based on the results of a prior actual machine test, the correspondence relationship between the opening degree control value X (number of steps) and the flow rate ratio k in the hybrid valve 80 can be obtained. Thereby, for the hybrid valve 80, a reference correspondence relationship between the opening degree control value X and the flow rate ratio k can be determined in advance as a reference characteristic line (X-k) for the flow rate ratio.

Therefore, the controller 200 can execute hot water outlet temperature control by calculating the opening degree control value X backward from the flow rate ratio k* calculated by formula (4) to control the hybrid valve 80.

Similarly, the correspondence relationship between the opening degree control value X of the hybrid valve 80 and the total flow rate Qt, that is, the reference characteristic line (X-Qt) for the total flow rate Qt in the flow rate control region 92, can be determined in advance based on the results of an actual machine test or the like using the flow rate detection value of the flow rate sensor 150 at the time when the opening degree control value X of the hybrid valve 80 is changed in the flow rate control region 92.

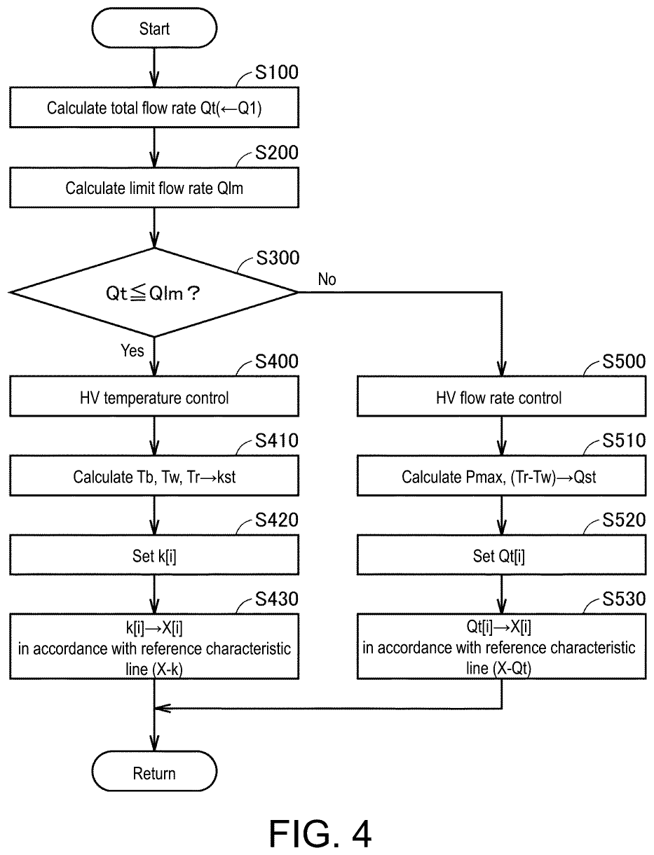

FIG. 4 is a flowchart illustrating the control process for the hybrid valve in the hot water supply apparatus of FIG. 1. The process of the flowchart shown in FIG. 4 can be periodically executed by the controller 200 during the hot water supply operation. In addition, although the description is omitted from FIG. 4, the controller 200 can acquire the values (Tw, Tb, Tw, Q1) detected by the respective sensors for each control cycle in which the process shown in FIG. 4 is executed.

With reference to FIG. 4, the controller 200 calculates the total flow rate Qt from the flow rate Q1 detected by the flow rate sensor 150 in step (hereinafter, also simply referred to as “S”) 100. At this time, the total flow rate Qt can be calculated according to formula (5) using the flow rate ratio k calculated backward from the current opening degree control value X of the hybrid valve 80 according to the reference characteristic line (X-k).

$$Q t = Q 1 + Q 2 = ( 1 + k ) \cdot Q 1 \qquad ( 5 )$$

The controller 200 sets the limit flow rate Qlm according to formula (1) using the detection value (temperature sensor 110) of the water inlet temperature Tw and the hot water supply setting temperature Tr, and the maximum heating amount Pmax, which is a specification value of the hot water supply apparatus 100, in S200. Alternatively, in S200, as described above, the limit flow rate Qlm may be set in a manner further combining flow rate control that limits the limit flow rate Qlm to be equal to or less than the can body maximum flow rate Q1max.

In S300, the controller 200 compares the total flow rate Qt calculated in S100 with the limit flow rate Qlm calculated in S200. When the total flow rate Qt is equal to or less than the limit flow rate Qlm (when determined as YES in S300), the controller 200 advances the process to S400 and executes temperature control, in which the opening degree control value X of the hybrid valve 80 is set within the temperature control region 91 (FIG. 3), in the control cycle.

On the other hand, when the total flow rate Qt is greater than the limit flow rate Qlm (when determined as NO in S300), the controller 200 advances the process to S500 and executes flow rate control, in which the opening degree control value X of the hybrid valve 80 is set within the flow rate control region 92 (FIG. 3), in the control cycle.

When executing temperature control (S400), the controller 200 calculates the target flow rate ratio kst, which is the target value of the flow rate ratio k for temperature control, using the detection values of the water inlet temperature Tw and the can body temperature Tb in the control cycle and the hot water supply setting temperature Tr in accordance with the flow rate ratio k* in the above formula (4) in S410. That is, it is set that kst=k*=(Tb−Tr)/(Tr−Tw).

In S420, the controller 200 calculates the flow rate ratio k[i] in the current control cycle in accordance with the target flow rate ratio kst calculated in S410. In S420, the target flow rate ratio kst may be set directly to the flow rate ratio k[i], or the flow rate ratio k[i] may be set by further reflecting a feedback control term based on the deviation between the hot water outlet temperature Th and the hot water supply setting temperature Tr.

Furthermore, in S430, the controller 200 sets the opening degree control value X[i] of the hybrid valve 80 in the i^{th} control cycle within the temperature control region 91 from the flow rate ratio k[i] calculated in S420 in accordance with the reference characteristic line (X-k) for the flow rate ratio k.

On the other hand, when executing flow rate control (S500), the controller 200 sets the target total flow rate Qst in flow rate control in S510. The target total flow rate Qst in S510 is set to be equal to or less than the limit flow rate Qlm. Thereby, the heating amount provided by the heating part (combustion burners 30) can be set within a range equal to or less than the maximum heating amount Pmax. In addition, by setting the limit flow rate Qlm reflecting the can body maximum flow rate Q1max, the flow rate Q1 can be limited to or less than the can body maximum flow rate Q1max under the flow rate ratio kmin (FIG. 3) in the flow rate control region 92.

In S520, the controller 200 calculates the total flow rate Qt[i] in the current control cycle in accordance with the target total flow rate Qst set in S510. For example, in S520, the target total flow rate Qst can be set directly to the total flow rate Qt[i].

Furthermore, in S530, the controller 200 sets the opening degree control value X[i] of the hybrid valve 80 in the i^{th} control cycle within the flow rate control region 92 from the total flow rate Qt[i] calculated in S520 in accordance with the reference characteristic line (X−Qt) for the total flow rate Qt.

The hot water outlet temperature control is executed by combining the control of the hybrid valve 80 shown in FIG. 4 with the control of the heating amount provided by the heating part (combustion burners 30).

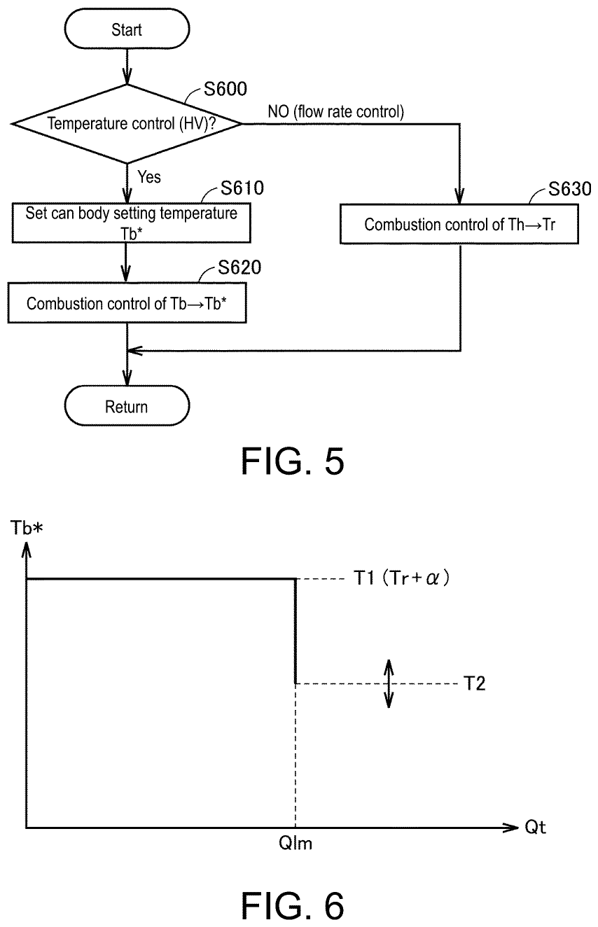

FIG. 5 shows a flowchart illustrating the combustion control of the combustion burners in the hot water supply apparatus 100.

With reference to FIG. 5, in S600, the controller 200 branches the process of combustion control according to whether the hybrid valve (HV) 80 performs temperature control or flow rate control. The determination in S600 can be executed in the same manner as in S300 of FIG. 4.

When temperature control is executed (when determined as YES in S600), the controller 200 sets the can body setting temperature Tb*, which is the target temperature of the can body temperature Tb, in S610. Then, in S620, combustion control is executed to adjust the heating amount provided by the combustion burners 30 so that the can body temperature Tb (temperature sensor 120) becomes the can body setting temperature Tb*.

For example, in S620, the heating amount provided by the combustion burners 30 can be set in accordance with the product of the temperature difference between the can body setting temperature Tb* and the water inlet temperature Tw, and the total flow rate Qt (S100). Alternatively, it is also possible to set the heating amount provided by the combustion burners 30 further reflecting a feedback control term for compensating for the deviation between the can body temperature Tb (temperature sensor 120) and the can body setting temperature Tb*.

As described above, the heating amount provided by the combustion burners 30 can be adjusted by a combination of the opening/closing pattern of the capacity switching valves 35a to 35c (number of burners) and the opening degree (gas flow rate) of the gas proportional valve 33.

On the other hand, when flow rate control is executed (when determined as NO in S600), in S630, the controller 200 executes combustion control to adjust the heating amount (that is, the amount of gas) provided by the combustion burners 30 in accordance with comparison between the hot water outlet temperature Th (temperature sensor 130) and the hot water supply setting temperature Tr. Thereby, temperature control can be executed to set the hot water outlet temperature Th to the hot water supply setting temperature Tr even when the flow rate ratio k based on the hybrid valve 80 is constant.

As described above, when the limit flow rate Qlm is set so that the flow rate Q1 is equal to or less than the can body maximum flow rate Q1max, in the flow rate control region 92, the flow rate can be controlled so that Q1≤Q1max under the flow rate ratio kmin (FIG. 3), and the heating amount provided by the combustion burners 30 can be controlled so that the hot water outlet temperature Th becomes the hot water supply setting temperature Tr within the range where the heating amount provided by the combustion burners 30 is equal to or less than the maximum heating amount Pmax.

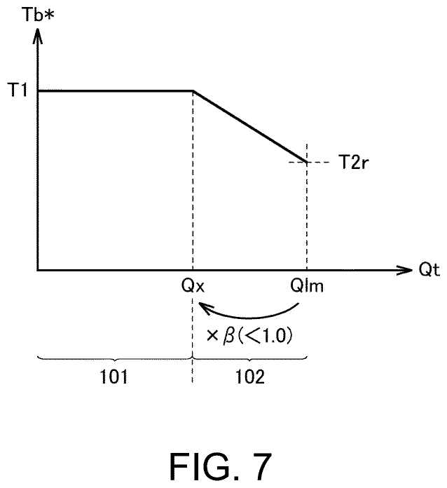

Next, the setting of the can body setting temperature Tb* during temperature control of the hybrid valve 80 will be described. FIG. 6 shows a comparative example of setting of the can body setting temperature Tb*, and FIG. 7 shows an example of setting the can body setting temperature Tb* according to this embodiment.

Considering the can body temperature Tb, if the can body temperature Tb is low, condensation is likely to occur on the surface of the heat exchanger 10. In addition, assuming that it is a situation where the hot water outlet temperature Th is to be maintained when the flow rate increases, it is understood that maintaining the hot water outlet temperature Th by adjusting the flow rate ratio k provides higher control responsiveness than maintaining the hot water outlet temperature Th by increasing the heating amount.

Therefore, in a situation where the hybrid valve 80 operates within the temperature control region 91 (during temperature control), the can body temperature Tb is set high, and then the hot water outlet temperature Th is controlled to the hot water supply setting temperature Tr by adjusting the flow rate ratio k.

On the other hand, in a situation where the hybrid valve 80 operates within the flow rate control region 92 (during temperature control), the flow rate ratio k is fixed at kmin in FIG. 3, and then the hot water outlet temperature Th is controlled to the hot water supply setting temperature Tr by adjusting the heating amount of the combustion burners 30. Therefore, the can body temperature Tb is determined from the hot water outlet temperature Th and the flow rate ratio kmin, and thus is not directly controlled by combustion control.

Thus, in the comparative example of FIG. 6, during the temperature control of Qt≤ Qlm, the can body setting temperature Tb* is set to a temperature T1 (T1=Tr+a) obtained by adding a fixed value a (for example, a-approximately 15 to 20° C.) to the hot water supply setting temperature Tr. In this case, the can body setting temperature Tb* is set to a constant value (T1) with respect to a change in the total flow rate Qt.

In contrast thereto, for the flow rate control of Qt>Qlm, the can body setting temperature Tb* is not set, and the actual can body temperature Tb becomes a temperature T2 determined from the hot water outlet temperature Th and the flow rate ratio kmin in the flow rate control region 92 (Tb=T2).

However, in the case where the can body setting temperature Tb* during temperature control is set according to the comparative example of FIG. 6, there is a concern that the following problem may occur in the control of the hot water outlet temperature Th when switching from temperature control to flow rate control in response to an increase in the total flow rate Qt.

During temperature control, the flow rate ratio k is controlled by the relationship between the can body temperature Tb (can body setting temperature Tb*), the hot water outlet temperature Th (hot water supply setting temperature Tr), and the water inlet temperature Tw without directly depending on the total flow rate Qt, as illustrated in formulas (2) and (3). Thus, there is a possibility that the difference between the flow rate ratio k during temperature control and the flow rate ratio (minimum value kmin) in the flow rate control region 92 may be relatively large.

When directly switching from temperature control to flow rate control in such a state, due to the difference between the can body temperature Tb controlled to the can body setting temperature Tb* and the can body temperature (T2) during flow rate control, there is a risk that the hot water outlet temperature Th may be higher than the hot water supply setting temperature Tr. Thus, the limitation of the total flow rate Qt cannot be started immediately, and after setting a transition period for adjusting the heating amount of the combustion burners 30 to lower the can body temperature Tb while continuing the temperature control based on the flow rate ratio k, it is necessary to start flow rate control to limit the total flow rate Qt. During such a transition period, the total flow rate Qt becomes greater than the limit flow rate Qlm, which causes the hot water outlet temperature Th to decrease, temporarily decreasing the accuracy of temperature control.

In contrast thereto, in the example of setting the can body setting temperature according to the embodiment of the disclosure, a flow rate region in which the can body setting temperature Tb* decreases as the total flow rate Qt increases is set near the limit flow rate Qlm within the flow rate region of Qt<Qlm where temperature control is applied.

As shown in FIG. 7, the boundary flow rate Qx is set by multiplying the limit flow rate Qlm by a coefficient β (0<β<1.0), and in the first flow rate region 101 of Qt≤Qx, the can body setting temperature Tb* is set to Tb*=T1 (T1=Tr+α) as in the comparative example of FIG. 6. That is, in the first flow rate region 101, the can body setting temperature Tb* is constant with respect to a change in the total flow rate Qt.

In contrast thereto, in the second flow rate region 102 of Qx<Qt≤Qlm, the can body setting temperature Tb* is set to decrease from the constant value T1 as the total flow rate Qt increases.

For example, the calculated temperature T2r of the can body temperature Tb during flow rate control can be calculated using the hot water supply setting temperature Tr and the flow rate ratio kmin in the flow rate control region 92. Therefore, when Qt-Qx, Tb*=T1, and when Qt=Qlm, Qb*=T2r, in the range of Qx<Qt<Qlm, the can body setting temperature Tb* in the second flow rate region 102 can be set to decrease at a constant rate with respect to an increase in the total flow rate Qt.

The calculated temperature T2r can, for example, be set in accordance with formula (7) by modifying the following formula (6) using the flow rates Q1 and Q2, the hot water supply setting temperature Tr, and the water inlet temperature Tw (detected temperature) and setting the flow rate ratio k (k=Q2/Q1)=kmin (flow rate control region 92). The calculated temperature T2r corresponds to the “lower limit setting value” of the can body setting temperature Tb*.

$$Q 1 \cdot T 2 r + Q 2 \cdot Tw = ( Q 1 + Q 2 ) \cdot Tr \qquad ( 6 )$$

$$T 2 r = Tr + k min \cdot ( Tr - Tw ) \qquad ( 7 )$$

That is, in this embodiment, the setting of the can body setting temperature Tb* during temperature control in S610 of FIG. 5 can be executed according to FIG. 7. The boundary flow rate Qx in FIG. 7 may be set according to the difference of a predetermined flow rate from the limit flow rate Qlm. In this way, the rate at which the can body setting temperature Tb* changes in response to an increase in the total flow rate Qt can be fixed. In any case, the first flow rate region 101 (Qt≤ Qx) is located on the lower flow rate side than the second flow rate region 102 (Qx<Qt≤ Qlm).

Thereby, in the hot water supply apparatus according to this embodiment, it is possible to suppress the temperature difference between the can body temperature Tb during temperature control before the transition and the can body temperature Tb (corresponding to T2 in FIG. 6) after the transition to flow rate control, when transitioning from temperature control to flow rate control as the total flow rate Qt increases. As a result, flow rate control for limiting the total flow rate Qt to the limit flow rate Qlm or less in response to an increase in the total flow rate Qt can be started without setting the “transition period” illustrated in FIG. 6. Therefore, by suppressing a temporary decrease in temperature control accuracy when switching from temperature control to flow rate control, the accuracy of temperature control can be improved.

Although FIG. 1 illustrates a configuration example in which the flow rate sensor 150 is disposed in the can body piping 55 to detect the flow rate Q1, it is possible to apply the control process of FIG. 4 and FIG. 5 according to this embodiment in a similar manner even to a configuration in which the flow rate sensor 150 is disposed in the bypass piping 60 to detect the flow rate Q2. Alternatively, even in a configuration in which the flow rate sensor 150 is disposed in the water inlet passage 50 to detect the total flow rate Qt (Q1+Q2), it is possible to apply a similar control process by calculating the flow rates Q1 and Q2 using the flow rate ratio k.

Further, although FIG. 1 shows an example in which the heat source of the “heating part” is the combustion heat of gas fuel, the fuel is not limited to gas, and the hot water outlet temperature control according to this embodiment can be applied to a hot water supply apparatus in which the “heating part” is constituted by a mechanism that generates the combustion heat of any fuel.

Although this embodiment illustrates a configuration example in which the hybrid valve 80 is connected between the water inlet passage 50 and the can body piping 55 and the bypass piping 60 to control the distribution ratio of low-temperature water from the water inlet passage 50 to the can body piping 55 and the bypass piping 60, the hybrid valve 80 may be disposed at the junction 75 and connected between the hot water outlet passage 70 and the can body piping 55 and the bypass piping 60. In this case, at the junction 75 in FIG. 2, the third port 83 is connected to the hot water outlet passage 70, and the flow direction at each port is reversed. Then, by controlling the flow rate Q1 and the flow rate Q2 according to the flow rate ratio (Q2/Q1) and the total flow rate (Q1+Q2) shown in FIG. 3, the mixture ratio of the high-temperature water in the can body piping 55 and the low-temperature water in the bypass piping 60 is controlled.

The embodiments disclosed herein should be considered as illustrative in all aspects and not restrictive. The scope of the disclosure is defined by the claims, rather than the above description, and is intended to include all modifications within the meaning and scope equivalent to the scope of the claims.

What is claimed is:

1. A hot water supply apparatus for mixing low-temperature water and high-temperature water, the hot water supply apparatus comprising:
a heating part that outputs high-temperature water by heating the low-temperature water;
a first flow path for the low-temperature water to flow through the heating part;
a second flow path through which the low-temperature water flows without passing through the heating part;
a flow rate detector that is disposed in the first flow path or the second flow path;
a control valve that is connected to the first flow path and the second flow path for controlling flow rates of the first flow path and the second flow path; and
a control device that sets a control value of the control valve and a heating amount provided by the heating part in order to control a hot water outlet temperature after mixing of the low-temperature water and the high-temperature water to a hot water supply setting temperature,
wherein the control valve is configured so that a first section and a second section exist with respect to a change in the control value, wherein in the first section, a flow rate ratio of the first flow path and the second flow path changes without affecting a total flow rate of the first flow path and the second flow path, and in the second section, the flow rate ratio is fixed while the total flow rate decreases,
in a case where the total flow rate acquired based on a detection flow rate of the flow rate detector is greater than a limit flow rate set corresponding to a maximum heating amount of the heating part, the control device sets the control value of the control valve within the second section so that the total flow rate is equal to or less than the limit flow rate, and controls the heating amount of the heating part so as to control the hot water outlet temperature to the hot water supply setting temperature,
in a case where the total flow rate acquired based on the detection flow rate of the flow rate detector is equal to or less than the limit flow rate, the control device controls the heating amount of the heating part so as to control a temperature of the high-temperature water to a can body setting temperature, and sets the control value of the control valve within the first section in accordance with the flow rate ratio for controlling the hot water outlet temperature to the hot water supply setting temperature, and
the can body setting temperature is set so that a flow rate region exists, in which the can body setting temperature decreases as the total flow rate increases and approaches the limit flow rate.

2. The hot water supply apparatus according to claim 1, wherein the can body setting temperature is set to a constant value higher than the hot water supply setting temperature in a first flow rate region on a lower flow rate side than a boundary flow rate set lower than the limit flow rate, and set to decrease from the constant value as the total flow rate increases in a second flow rate region between the boundary flow rate and the limit flow rate.

3. The hot water supply apparatus according to claim 2, wherein the can body setting temperature set in the second flow rate region is set to gradually decrease from the constant value to a lower limit setting value corresponding to the temperature of the high-temperature water for setting the hot water outlet temperature to the hot water supply setting temperature under the flow rate ratio in the second section of the control valve, as the total flow rate increases.

4. The hot water supply apparatus according to claim 2, wherein the constant value is set according to a sum of the hot water supply setting temperature and a predetermined fixed value.

5. The hot water supply apparatus according to claim 1, wherein the limit flow rate is set in accordance with a second value in a case where the second value is smaller than a first value, wherein the second value corresponds to the total flow rate when the flow rate of the first flow path becomes an allowable maximum flow rate of the heating part under the flow rate ratio in the second section of the control valve, and the first value corresponds to the total flow rate that is capable of setting the hot water outlet temperature to the hot water supply setting temperature when the maximum heating amount of the heating part occurs.

6. The hot water supply apparatus according to claim 2, wherein the limit flow rate is set in accordance with a second value in a case where the second value is smaller than a first value, wherein the second value corresponds to the total flow rate when the flow rate of the first flow path becomes an allowable maximum flow rate of the heating part under the flow rate ratio in the second section of the control valve, and the first value corresponds to the total flow rate that is capable of setting the hot water outlet temperature to the hot water supply setting temperature when the maximum heating amount of the heating part occurs.

7. The hot water supply apparatus according to claim 3, wherein the limit flow rate is set in accordance with a second value in a case where the second value is smaller than a first value, wherein the second value corresponds to the total flow rate when the flow rate of the first flow path becomes an allowable maximum flow rate of the heating part under the flow rate ratio in the second section of the control valve, and the first value corresponds to the total flow rate that is capable of setting the hot water outlet temperature to the hot water supply setting temperature when the maximum heating amount of the heating part occurs.

8. The hot water supply apparatus according to claim 4, wherein the limit flow rate is set in accordance with a second value in a case where the second value is smaller than a first value, wherein the second value corresponds to the total flow rate when the flow rate of the first flow path becomes an allowable maximum flow rate of the heating part under the flow rate ratio in the second section of the control valve, and the first value corresponds to the total flow rate that is capable of setting the hot water outlet temperature to the hot water supply setting temperature when the maximum heating amount of the heating part occurs.
